(19) United States
(12) Patent Application Publication
(10) Pub. No.: US 2011/0199265 A1
(43) Pub. Date: Aug. 18, 2011

(54) THREE-BAND ANTENNA DEVICE WITH RESONANCE GENERATION AND PORTABLE ELECTRONIC DEVICE HAVING THE SAME

(76) Inventors: Hsiao-Kuang LIN, Taipei City (TW); Yu-Cheng Chang, Taipei City (TW); Chih-Chun Chang, Taipei City (TW)

(21) Appl. No.: 13/020,529

(22) Filed: Feb. 3, 2011

(30) Foreign Application Priority Data
Feb. 12, 2010 (TW) 099104729

(51) Int. Cl. H01Q 1/38

(52) U.S. Cl. 343/700 MS

(57) ABSTRACT

A three-band antenna device with resonance generation includes a dielectric layer having an upper surface and a lower surface, a grounding element, a first radiating element, and a second radiating element. The first radiating element is arranged on the upper surface for providing a first frequency band. The second radiating element is arranged on the lower surface and stacked below the first radiating element via the dielectric layer for providing a second frequency band, so as to generate a parasitic capacitance therebetween. A third frequency band is provided by the resonance of the parasitic capacitance and the parasitic inductance in the second radiating element.

### BACKGROUND OF THE INVENTION

1. Field of the Invention

The present invention relates to a three-band antenna device with resonance generation and, more particularly, to a three-band antenna device capable of transmitting and receiving signals in three different frequency bands simultaneously without increasing the antenna size.

2. Description of Related Art

Recently, electronic devices with wireless communication capabilities have become more and more popular, many different types of communication protocols have been formulated, and many frequency bands can be used. Thus, the frequency band of the internal antennas installed in electronic devices, such as notebook computers, should cover many different frequency bands for different wireless communication protocols.

Since planar inverted-F antenna (PIFA) has advantages such as simple structure, convenient production, easy integration, low profile, good performance and small size, it is widely applied in portable electronic devices. With reference to FIG. 1, FIG. 1 is a schematic diagram of a typical one-band PIFA. As shown in FIG. 1, PIFA 1 includes a radiating part 11, a grounding part 12, a feeding part 13, a grounding element 14 and a feeding element 15, wherein the grounding part 12 is connected to the grounding element 14, the feeding part 13 is connected to the feeding element 15 for feeding, and the feeding part 13 is preferably an coaxial cable with a surrounding grounding layer 131 connected to the grounding element 14, wherein the length L11 of the radiating part 11 should be the quarter wavelength of the center frequency of the wanted frequency band or its multiples.

In the prior art, the number of radiating elements in an antenna increases with the number of desired frequency bands; namely, a two-band antenna should have two radiating elements, and a three-band antenna should have three radiating elements for resonating three frequency bands. Thus, the size of a multi-band antenna adapted for multi-frequency band wireless communication electronic devices is too large, and thus cannot satisfy the consumers' expectation of compact size.

Therefore, it is desirable to provide a small-sized three-band antenna device with resonance generation to mitigate and/or obviate the aforementioned problems.

### SUMMARY OF THE INVENTION

The object of the present invention is to provide a three-band antenna device with resonance generation and a portable electronic device having the same, which can resonate to generate three frequency bands by two radiating elements without increasing antenna size.

According to one aspect of the invention, a three-band antenna device with resonance generation is provided. The three-band antenna device with resonance generation comprises: an isolating dielectric layer having a first surface and a second surface; a first radiating element installed on the first surface for resonating to generate a first frequency band having a first center frequency, wherein a feeding part and a grounding part are installed on the first radiating element; a second radiating element for resonating to generate a second frequency band with the first radiating element, the second frequency band having a second center frequency greater than the first center frequency, the second radiating element being installed on the second surface and stacked below the first radiating element across the isolating dielectric layer so as to generate a parasitic capacitance between the first radiating element and the second radiating element; a feeding element connected to the feeding part for feeding; and a grounding element connected to the grounding part. The parasitic capacitance between the first radiating element and the second radiating element and the parasitic inductance of the second radiating element resonate to generate a third frequency band having a third center frequency, which is greater than the second center frequency.

According to another aspect of the invention, a portable electronic device having a three-band antenna device with resonance generation is provided. The three-band antenna device comprises: an isolating dielectric layer having a first surface and a second surface; a first radiating element installed on the first surface for resonating to generate a first frequency band having a first center frequency, wherein a feeding part and a grounding part are installed on the first radiating element; a second radiating element for resonating to generate a second frequency band with the first radiating element, the second frequency band having a second center frequency greater than the first center frequency, the second radiating element being installed on the second surface and stacked below the first radiating element across the isolating dielectric layer so as to generate a parasitic capacitance between the first radiating element and the second radiating element; a feeding element connected to the feeding part for feeding; and a grounding element connected to the grounding part. The parasitic capacitance between the first radiating element and the second radiating element and parasitic inductance of the second radiating element resonate to generate a third frequency band having a third center frequency, which is greater than the second center frequency.

Other objects, advantages, and novel features of the invention will become more apparent from the following detailed description when taken in conjunction with the accompanying drawings.

### BRIEF DESCRIPTION OF THE DRAWINGS

FIG. 1 is a schematic diagram of a typical one-band PIFA;

FIG. 2A is a perspective view of the first surface of the three-band antenna device according to the invention;

FIG. 2B is a perspective view of the second surface of the three-band antenna device according to the invention;

FIG. 3 is a schematic diagram illustrating the impedance variation of the second radiating element of the three-band antenna device in response to high-frequency electromagnetic wave according to one preferred embodiment of the invention;

FIG. 4 is a frequency response diagram of return loss of the three-band antenna device according to one preferred embodiment of the invention;

FIG. 5 is a block diagram of the three-band antenna device fed by a coaxial cable according to one preferred embodiment of the invention;

FIG. 6 is a schematic diagram of the three-band antenna device installed in a notebook computer according to one preferred embodiment of the invention;

FIG. 7A is a perspective view of the three-band antenna device fed by co-plane waveguide according to one preferred embodiment of the invention;

FIG. 7B is a schematic diagram illustrating the reference ground of the feeding line of the three-band antenna device fed by co-plane waveguide according to one preferred embodiment of the invention;

FIG. 8A is a perspective view of the three-band antenna device fed by the micro strip line according to one preferred embodiment of the invention;

FIG. 8B is a schematic diagram illustrating the reference ground of the micro strip line of the three-band antenna device fed by the micro strip line according to one preferred embodiment of the invention;

FIG. 9 is a block diagram of the three-band antenna device installed with the matching network according to one preferred embodiment of the invention;

FIG. 10 is a perspective view of the three-band antenna device fed by the pogo pin according to one preferred embodiment of the invention; and

FIG. 11 is a schematic diagram of the second radiating element of the three-band antenna device according to one preferred embodiment according of the invention.

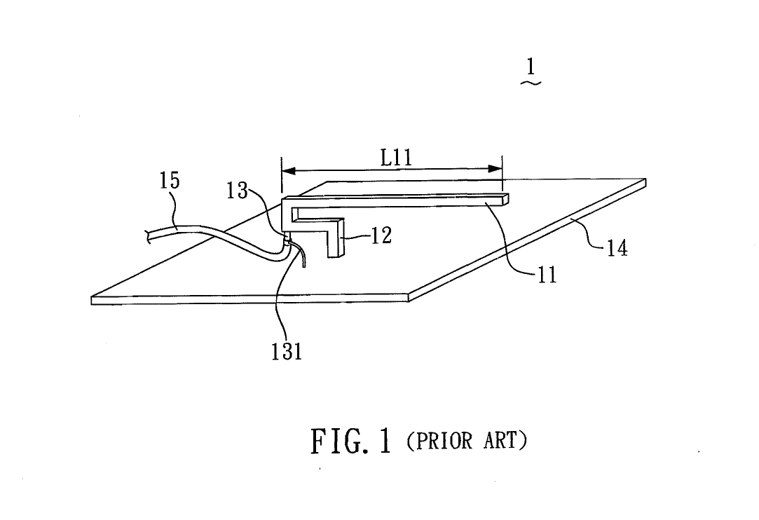

### DETAILED DESCRIPTION OF THE PREFERRED EMBODIMENT

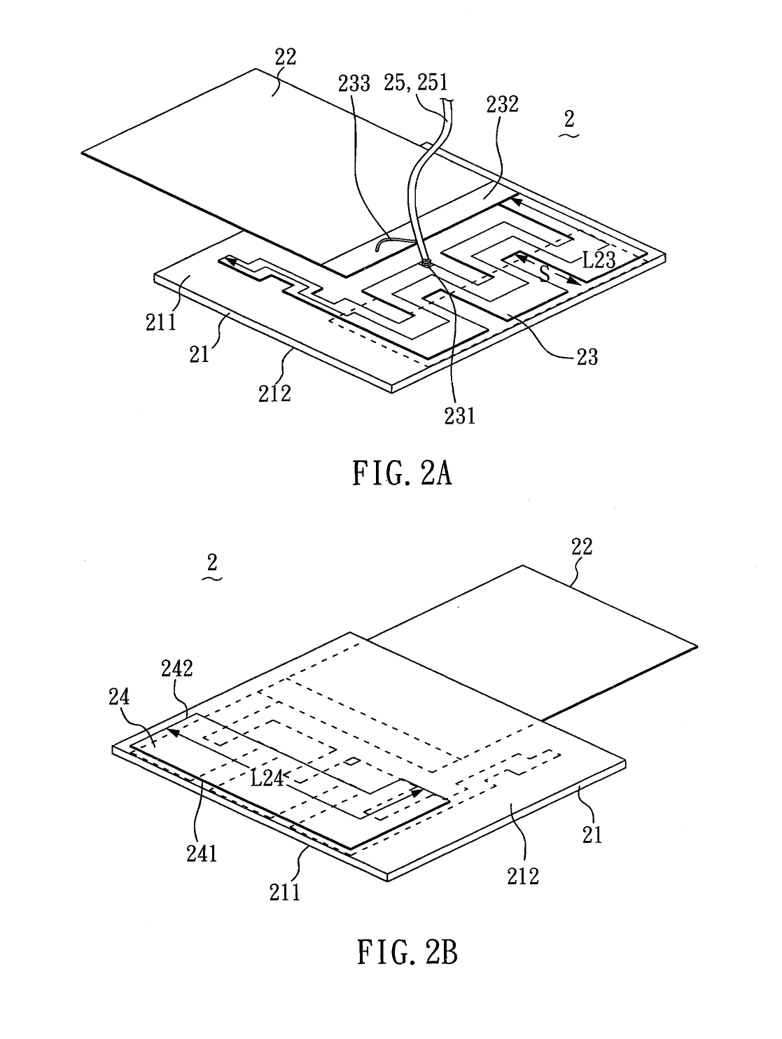

Please refer to FIGS. 2A and 2B. FIGS. 2A and 2B are perspective views of the first and second surfaces 211, 212 of the three-band antenna device 2 according to the invention. The three-band antenna device 2 comprises an isolating dielectric layer 21, a grounding element 22, a first radiating element 23, a second radiating element 24 and a feeding element 25. The isolating dielectric layer 21 is composed of non-conducting material, which can be a printed circuit board or air and is preferably a rectangular-shaped FR4 printed circuit board. The grounding element 22, the first radiating element 23 and the second radiating element 24 are preferably thin metal films. The isolating dielectric layer 21 includes the first and second surfaces 211, 212. The first radiating element 23 installed on the first surface 211 sets up a feeding part 231 and a grounding part 232 on it, and the grounding part 232 is preferably connected the grounding element 22. The second radiating element 24 is installed on the second surface 212 and stacked below the first radiating element 23 across the isolating dielectric layer 21, and a parasitic capacitance is generated between the first radiating element 23 and the second radiating element 24. The feeding element 25 is connected to the feeding part 231 for feeding. In this embodiment, the grounding element 22 is installed on the first surface 211, but it also can be installed on the second surface 212 and connected to the grounding part 232 through a conducting wire. The feeding element 25 is a coaxial cable 251 with the surrounded grounding layer 233 connected to the grounding part 232.

As shown in FIGS. 2A and 2B, the radiating element 23 is a meander-line-shaped block with a gap length S. The second radiating element 24 is preferably a L-shaped block with a long side 241 and a short side 242, wherein the long side 241 is preferably aligned with the edge of the first radiating element 23, and the length of the short side 242 is preferably the same as the gap length S so as to generate the parasitic capacitance between the first radiating element 23 and the second radiating element 24.

The total length L23 of the first radiating element 23 is preferably equal to the quarter wavelength of the first center frequency f1 or its multiples, so as to resonate for generating the first frequency band BW_{f1}, which has the first center frequency f1. The total length L24 of the second radiating element 24 is preferably equal to the quarter wavelength of the second center frequency 12 or its multiples, so as to resonate for generating the second frequency band BW_{f2}, which has the second center frequency 12, with the first radiating element 23. The parasitic capacitance between the first radiating element 23 and the second radiating element 24, and the parasitic inductance of the second radiating element 24 resonate for generating the third frequency band BW_{f3}, which has the third center frequency B. The second center frequency 12 is greater than the first center frequency f1, and the third center frequency f3 is greater than the second center frequency f2.

Therefore, the three frequency bands BW_{f1}, BW_{f2} and BW_{f3} of the three-band antenna device 2 of the present invention can be adjusted. Since the total length L23 of the first radiating element 23 is preferably equal to the quarter wavelength of the first center frequency f1 or its multiples, the first frequency bands BW_{f1} can be decided by adjusting the size of the first radiating element 23. Since the second frequency band BW_{f2} and the third frequency band BW_{f3} are respectively generated from resonation by the second radiating element 24 and the first radiating element 23, and the second radiating element 24 and the parasitic capacitance, the second frequency band BW_{f2} and the third frequency band BW_{f3} can be tuned by adjusting the shape and the size of the second radiating element 24 and matching impedance, and finely adjusting the size of the grounding element 22 to optimize matching.

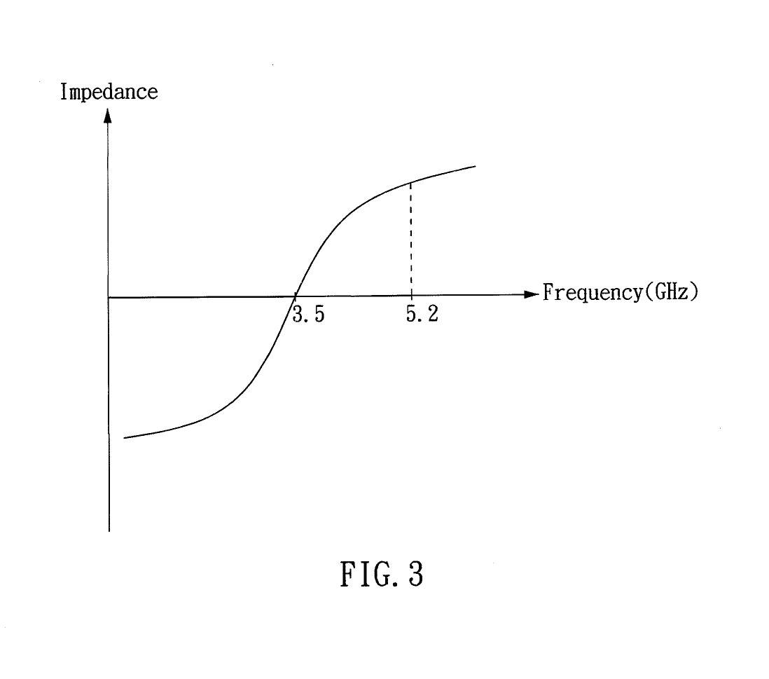

With reference to FIG. 3, FIG. 3 is a schematic diagram of impedance variation of the second radiating element 24 of the three-band antenna device 2 in response to high-frequency electromagnetic wave according to one preferred embodiment of the invention. The impedance of the second radiating element 24 is equivalent to a capacitor connected to an inductor, the capacitance and inductance characteristics are not obvious in the low frequency situation, but when high frequency electromagnetic wave responds on the second radiating element 24, if the frequency of the high frequency electromagnetic wave is smaller than 3.5 GHz, the second radiating element 24 shows capacitance characteristics, which is known as the parasitic capacitance, and if the frequency is greater than 3.5 GHz, the second radiating element 24 shows inductance characteristics, which is known as the parasitic inductance.

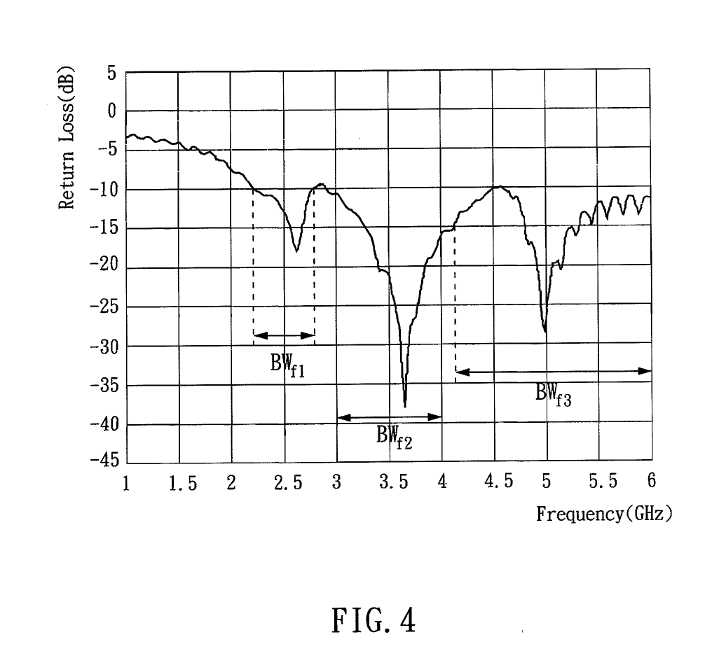

With reference to FIG. 4, FIG. 4 is a frequency response diagram of return loss of the three-band antenna device 2 according to one preferred embodiment of the invention, which is obtained from actual measurement. In this embodiment, the isolating dielectric layer is a rectangle-shaped FR4 printed circuit board with dielectric constant of 4, length of 22 mm, width of 9 mm and thickness of 0.4 mm. The grounding element 22, the first radiating element 23 and the second radiating element 24 are all copper films with thickness of 0.02 mm. From FIG. 4, the first frequency band BW_{f1} of the three-band antenna device 2 is 2.2 GHz to 2.8 GHz, the first center frequency f1 is 2.5 GHz, the second frequency band BW_{f2} is 3 GHz to 4 GHz, the second center frequency f2 is 3.5 GHz, the third frequency band BW_{f3} is 4.2 GHz to 6 GHz, the third center frequency f3 is 5 GHz. Thus, the three-band antenna device of the present invention can satisfy the frequency band of 2 GHz for Wi-Fi and WiMAX, the frequency band of 3 GHz for WiMAX and the frequency band of 5 GHz for 802.11a and WiMAX respectively, namely, all of the frequency bands for WLAN and WiMAX at present.

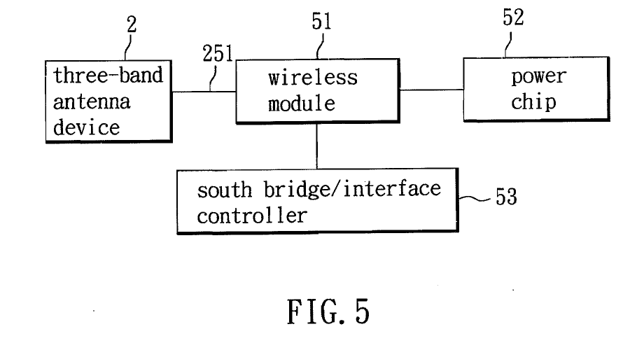

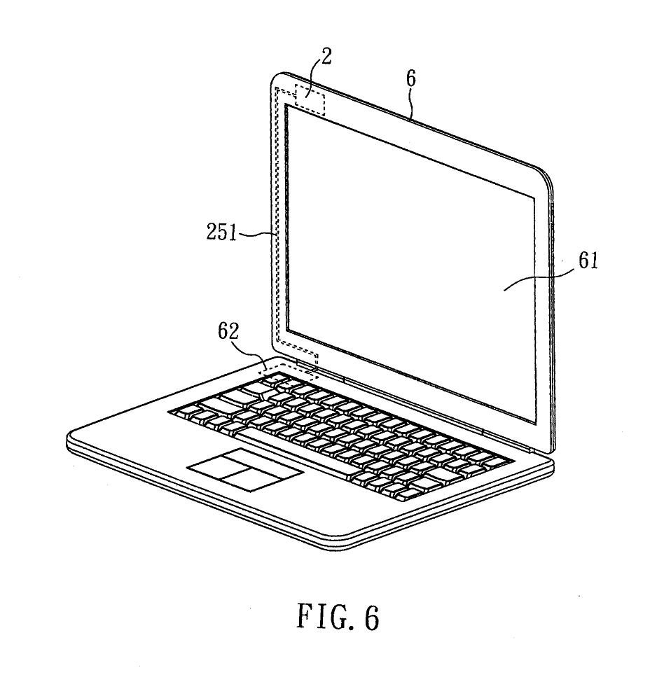

With reference to FIGS. 2A and 5, FIG. 5 is a block diagram of the three-band antenna device 2 fed by the coaxial cable 251 according to one preferred embodiment of the invention. The three-band antenna device 2 of the present invention is connected to the wireless module through a coaxial cable 251, which is preferably connected by connectors or welding. One end of the coaxial cable 251 is connected to the feeding part 231 of the three-band antenna device 2, the grounding layer 233 is connected to the grounding part 22 of the three-band antenna device 2 for optimizing impedance matching, and the other end of the coaxial cable 251 is connected to the wireless module 51. The wireless module 51 is supplied with power by the power chip 52 through power supply interface, and connected to the south-bridge/interface controller 53 of the system through physical transmission interface for transmitting data. The feeding method can be applied in notebook computers. With reference to FIG. 6, FIG. 6 is a schematic diagram of the three-band antenna device 2 installed in the notebook computer 6 according to one preferred embodiment of the invention. The three-band antenna device 2 is installed above the display panel 61 and connected to the wireless module 62 through the coaxial cable 251, and the grounding element 22 is preferably connected to the housing of the notebook computer 6 for grounding to optimize matching. It should be noticed that, the three-band antenna device 2 should avoid being close to metal objects such as speakers and vibration motors, and metal housing cannot be used on the rear projection location of the three-band antenna device 2, so as to avoid the shielding effect and ensure that it has the highest radiation efficiency.

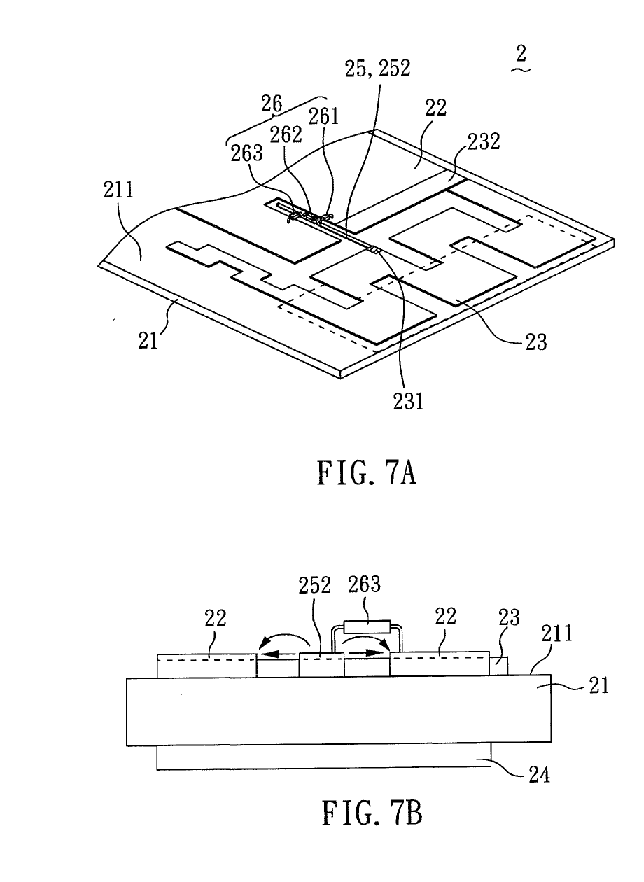

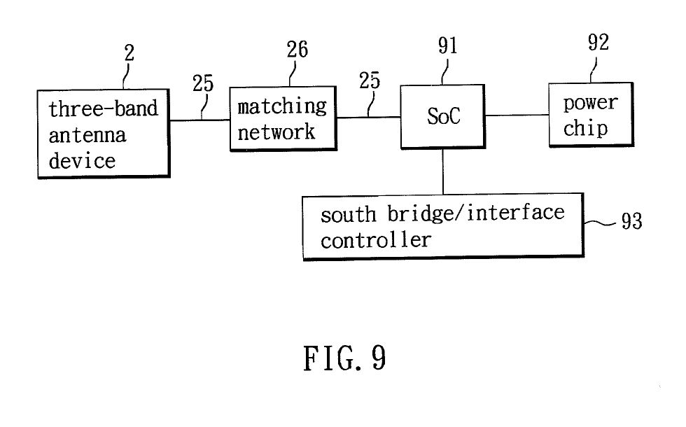

In addition to the abovementioned method of feeding by a coaxial cable, the three-band antenna device 2 can also be fed by using co-plane waveguide, a micro strip line, a pogo pin, and so on. If using the co-plane waveguide or micro strip line for feeding, the three-band antenna device 2 can be directly designed on the printed circuit board of an electronic device, the copper films on the upper and lower surfaces of printed circuit board can be used as the first and second radiating elements 23, 24, and the first radiating element 23 is directly fed by a printed circuit line on the printed circuit board. In the case, for manufacturers, the three-band antenna device 2 of the present invention can be used without increasing extra cost and antenna size, and it also can be installed in small-sized portable electronic devices, such as mobile phones, for satisfying the trend of miniaturization in electronic devices. With reference to FIG. 7A, FIG. 7A is a perspective view of the three-band antenna device 2 fed by co-plane waveguide according to one preferred embodiment of the invention. As shown in FIG. 7A, the grounding element 22, the first radiating element 23, the feeding element 25 and the matching network 26 are installed on the first surface 211 of the isolating dielectric layer 21, and the second radiating element 24 is installed on the second surface 212. The feeding element 25 is a feeding line 252, which is formed by printing a circuit line on the first surface 211 directly. One end of the feeding line 252 is connected to the feeding part 231 and the other end is connected to the System-on-a-chip (SoC) 91 in FIG. 9. The grounding element 22 surrounds two sides of the feeding line 252 and is connected to the grounding part 232. The matching network 26 is installed on the feeding line 252. In this embodiment, the matching network 26 includes passive components 261-263, which are capacitors or inductors.

With reference to FIG. 7B, FIG. 7B is a schematic diagram illustrating the reference ground of the feeding line of the three-band antenna device 2 fed by co-plane waveguide according to one preferred embodiment of the invention. As shown in FIG. 7B, the grounding element 22 surrounds two sides of the feeding line 252, and thus the high speed signals on the feeding line 252 take the grounding element 22 as reference ground to avoid signal interference and prevent signal from being interfered.

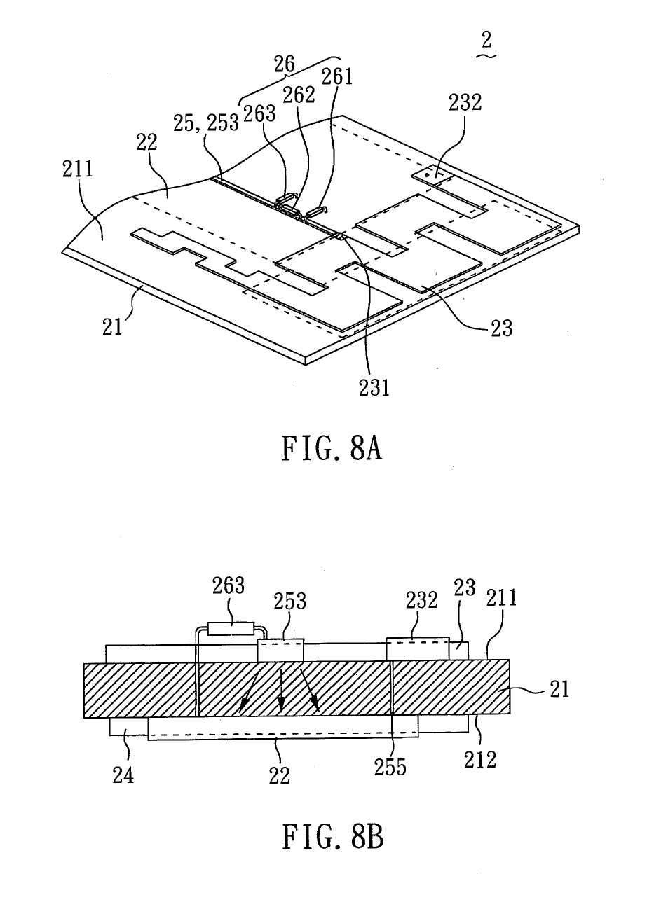

With reference to FIGS. 8A and 8B, FIG. 8A is a perspective view of the three-band antenna device 2 fed by the micro strip line according to one preferred embodiment of the invention, FIG. 8B is a schematic diagram illustrating the reference ground of the micro strip line 253 of the three-band antenna device 2 fed by the micro strip line according to one preferred embodiment of the invention. The first radiating element 23, the feeding element 25 and the matching network 26 are installed on the first surface 211 of the isolating dielectric layer 21, the grounding element 22 and the second radiating element 24 are installed on the second surface 212, and the grounding part 232 of the first radiating element 23 is preferably connected to the grounding element 22 through a via line 255. The feeding element 25 is a micro strip line 253, which is a printed circuit line connected to the feeding part 231 on the first surface 211. The grounding element 22 is located below the micro strip 253 across the isolating dielectric layer 21, and the high speed signals on the micro strip line 253 take the grounding element 22 as reference ground to avoid signal interference and prevent signal from being interfered. The matching network is preferably installed on the micro strip line 253. In this embodiment, the matching network 26 includes passive components 261-263, which are capacitors or inductors. The grounding pin of the passive component 263 is connected to the grounding element 22 through the via line 255.

With reference to FIG. 9, FIG. 9 is a block diagram of the three-band antenna device 2 installed with the matching network 26 according to one preferred embodiment of the invention. The matching network 26 can be applied in the aforementioned methods of feeding the three-band antenna device 2 by the co-plane microwave and micro strip line. The matching network 26 is installed on the feeding element 25 for tuning the first frequency band BW_{f1}, the second frequency band BW_{f2} and the third frequency band BW_{f3}. The matching network 26 preferably includes at least a passive component for performing appropriate adjustment based on the matching situation. The three-band antenna device 2 is connected to the SoC 91 through the feeding element 25, the SoC 91 is supplied with power by the power chip 92 through power supply interface, and connected to the south-bridge/interface controller 93 of the system through physical transmission interface.

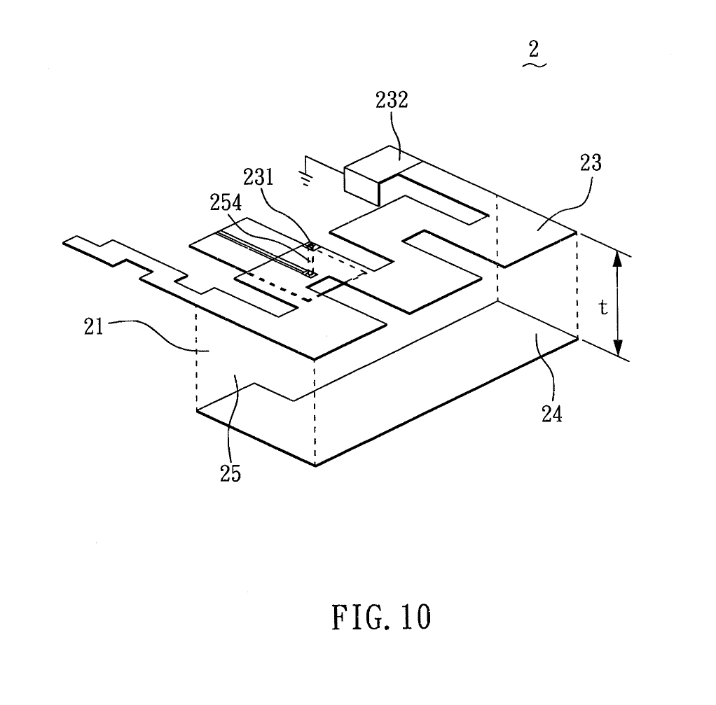

With reference to FIG. 10, FIG. 10 is a perspective view of the three-band antenna device 2 fed by the pogo pin according to one preferred embodiment of the invention. As shown in FIG. 10, the pogo pin 254 is connected to the feeding part 231 of the first radiating element 23 so as to lead signals out the feeding element 25. In this embodiment, the isolating dielectric layer is air, and two sides of the air layer is equivalent to the first and second surfaces 211, 212 of the isolating dielectric layer 21. The grounding part 232 of the first radiating element 23 is connected to the grounding element on the printed circuit board, or connected to the other large grounding plane of the electronic device installed with the three-band antenna device 2. The second radiating element 24 is attached on any nonmetal material. The distance t between the first radiating elements 23 and the second radiating elements 24 can be adjusted according to the desired frequency band.

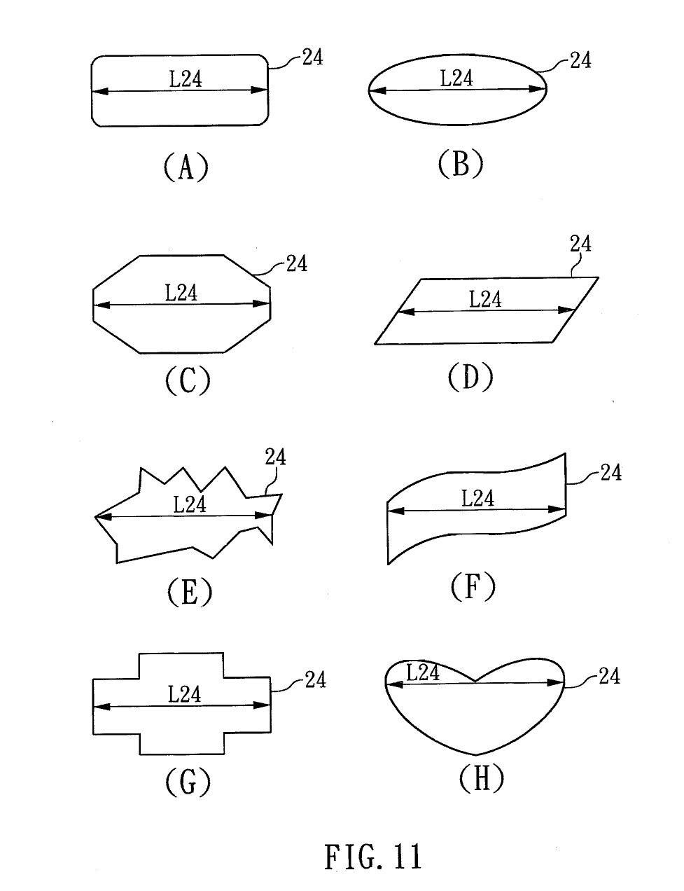

With reference to FIG. 11, FIG. 11 is a schematic diagram of the second radiating element 24 of the three-band antenna device 2 according to one preferred embodiment of the invention. As shown in FIG. 11, the shape of the second radiating element 24 of the three-band antenna device 2 according to the present invention is not limited. But it should be noticed that, the total length L24 of the second radiating element 24 should be the quarter wavelength of the second center frequency 1′2 or its multiples, and the frequency bands of the three-band antenna device 2 can be tuned by adjusting the shape of the radiating element 24.

In conclusion, the three-band antenna device of the present invention is provided with a metal plate configured behind a typical PIFA for coupling to generate a new resonance point; namely, three frequency bands can be generated from resonation by two radiating elements. Thus, the three-band antenna device can provide two new frequency bands without increasing antenna size and cost, to thereby provide a complete antenna configuration for various wireless communication standards. Moreover, since antenna size and cost are not increasing, the three-band antenna device of the present invention can be appropriately installed in portable electronic devices, such as notebook computers, personal digital assistants (PDA) or portable mobile phones, for satisfying consumers' expectation of compact size.

Although the present invention has been explained in relation to its preferred embodiment, it is to be understood that many other possible modifications and variations can be made without departing from the spirit and scope of the invention as hereinafter claimed.

What is claimed is:

1. A three-band antenna device with resonance generation comprising:
an isolating dielectric layer having a first surface and a second surface;
a first radiating element installed on the first surface for resonating to generate a first frequency band having a first center frequency, wherein a feeding part and a grounding part are installed on the first radiating element;
a second radiating element for resonating to generate a second frequency band with the first radiating element, the second frequency band having a second center frequency greater than the first center frequency, the second radiating element being installed on the second surface and stacked below the first radiating element across the isolating dielectric layer so as to generate a parasitic capacitance between the first radiating element and the second radiating element;
a feeding element connected to the feeding part for feeding; and
a grounding element connected to the grounding part;
wherein the parasitic capacitance between the first radiating element and the second radiating element and parasitic inductance of the second radiating element resonate to generate a third frequency band having a third center frequency, which is greater than the second center frequency.

2. The three-band antenna device as claimed in claim 1, wherein the grounding element is installed on the first surface and connected to the grounding part directly.

3. The three-band antenna device as claimed in claim 1, wherein the feeding element is a coaxial cable.

4. The three-band antenna device as claimed in claim 1, wherein the feeding element is a feeding line installed on the first surface, and the grounding element is installed on the first surface and surrounds two sides of the feeding line.

5. The three-band antenna device as claimed in claim 4, further comprising a matching network, which includes at least a passive component for adjusting the first frequency band, the second frequency band and the third frequency band.

6. The three-band antenna device as claimed in claim 1, wherein the feeding element is a feeding line installed on the first surface, and the grounding element is installed on the second surface and stacked below the feeding element across the isolating dielectric layer with connection to the grounding part through a conducting wire.

7. The three-band antenna device as claimed in claim 6, further comprising a matching network, which includes at least a passive component for adjusting the first frequency band, the second frequency band and the third frequency band.

8. The three-band antenna device as claimed in claim 4, wherein the feeding line is a printed circuit line formed on a printed circuit board.

9. The three-band antenna device as claimed in claim 1, wherein the feeding element is connected to the feeding part by a pogo pin.

10. The three-band antenna device as claimed in claim 1, wherein the second radiating element is a L-shaped block.

11. The three-band antenna device as claimed in claim 1, wherein the first radiating element is a meander-line-shaped block.

12. The three-band antenna device as claimed in claim 1, wherein the first radiating element has a gap length, the second radiating element has a long side and a short side, the long side is aligned with an edge of the first radiating element and the short side has a length equal to the gap length.

13. The three-band antenna device as claimed in claim 1, wherein the first radiating element has a total length equal to the quarter wavelength of the first center frequency or its multiples.

14. The three-band antenna device as claimed in claim 1, wherein the second radiating element has a total length equal to the quarter wavelength of the second center frequency or its multiples.

15. The three-band antenna device as claimed in claim 1, wherein the first center frequency is 2.5 GHz, and the first frequency band is 2.2 GHz to 2.8 GHz.

16. The three-band antenna device as claimed in claim 1, wherein the second center frequency is 3.5 GHz, and the second frequency band is 3 GHz to 4 GHz.

17. The three-band antenna device as claimed in claim 1, wherein the third center frequency is 5 GHz, and the third frequency band is 4.2 GHz to 6 GHz.

18. The three-band antenna device as claimed in claim 1, wherein the isolating dielectric layer is a printed circuit board or air.

19. The three-band antenna device as claimed in claim 18, wherein the printed circuit board is a rectangular-shaped FR4 printed circuit board.

20. The three-band antenna device as claimed in claim 1, wherein the grounding element, the first radiating element and the second radiating element are thin metal films.

21. A portable electronic device having a three-band antenna device with resonance generation, the three-band antenna device comprising:
an isolating dielectric layer having a first surface and a second surface;
a first radiating element installed on the first surface for resonating to generate a first frequency band having a first center frequency, wherein a feeding part and a grounding part are installed on the first radiating element;
a second radiating element for resonating to generate a second frequency band with the first radiating element, the second frequency band having a second center frequency greater than the first center frequency, the second radiating element being installed on the second surface and stacked below the first radiating element across the isolating dielectric layer so as to generate a parasitic capacitance between the first radiating element and the second radiating element;
a feeding element connected to the feeding part for feeding; and
a grounding element connected to the grounding part;
wherein the parasitic capacitance between the first radiating element and the second radiating element and parasitic inductance of the second radiating element resonate to generate a third frequency band having a third center frequency, which is greater than the second center frequency.

22. The portable electronic device as claimed in claim 21, which is a notebook computer, a personal digital assistant (PDA) or a portable mobile phone.
